(19) United States
(12) Patent Application Publication
(10) Pub. No.: US 2006/0247852 A1
(43) Pub. Date: Nov. 2, 2006

(54) System and method for providing safety-optimized navigation route planning

(76) Inventors: James M. Kortge, Ferndale, MI (US); Jing Zhang, Grosse Pointe Park, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/117,794

(22) Filed: Apr. 29, 2005

(51) Int. Cl. G01C 21/34

(52) U.S. Cl. 701/209; 701/211; 340/995.19

(57) ABSTRACT

A system and method is provided that facilitates the generation of a safety-optimized route between a starting location and a destination location. A vehicle navigation system configured in accordance with the invention accesses safety data indicative of the relative safety of potential route sections, processes the safety data for a potential route, and generates a proposed navigation plan that favors relatively safe route sections over relatively unsafe route sections.

### TECHNICAL FIELD

The present invention generally relates to vehicle navigation and route planning systems. More particularly, the present invention relates to a vehicle navigation system that provides route planning based on various safety considerations.

### BACKGROUND

A vehicle navigation system generally provides navigation instructions, location data, and map information to the vehicle operator. The prior art is replete with vehicle navigation systems that attempt to optimize a route based upon different factors. Route calculation is typically performed by examining a number of possible paths, and selecting the “best” path according to a number of optimization rules. For instance, the shortest possible route may be chosen to minimize the distance traveled or high-speed roads may be chosen to minimize travel time. Some advanced navigation systems utilize real-time traffic congestion data in an attempt to guide the vehicle away from traffic jams. After the optimization criteria have been selected, automated vehicle route guidance is typically performed in a two-step process: (1) a proposed route is calculated from the current position of the vehicle to the desired destination; and (2) guidance instructions are presented to the vehicle operator as the vehicle traverses the proposed route.

Some drivers, such as those enjoying a casual drive without any time constraints or restrictions on the number of miles traveled, may not find conventional navigation systems particularly useful. Other drivers may be more concerned about other factors that might otherwise influence their chosen route. For example, safety-minded drivers might be more concerned about finding a relatively safe route that has a statistically low accident rate and/or a route that avoids areas or neighborhoods having a statistically high crime rate.

Accordingly, it is desirable to have a vehicle navigation system that generates a proposed route in a manner that favors relatively safe routes over relatively unsafe routes, thereby enhancing the “peace of mind” of the driver and possibly reducing the driver's cognitive workload. In addition, it is desirable to have a vehicle navigation system that strives to increase safety by processing information about potentially dangerous roads and intersections and calculating routes that avoid dangerous roads and intersections. Furthermore, other desirable features and characteristics of the present invention will become apparent from the subsequent detailed description and the appended claims, taken in conjunction with the accompanying drawings and the foregoing technical field and background.

### BRIEF SUMMARY

A vehicle navigation system configured in accordance with an embodiment of the invention includes a route optimization mechanism that considers safety data when generating a proposed route. The navigation system can provide a proposed route that tends to avoid unsafe roads, intersections, and neighborhoods.

The above and other aspects of the invention may be carried out in one form by a navigation method for instructing an operator of a vehicle. The navigation method obtains a starting location and a destination location, processes safety data corresponding to a number of route sections between the starting and destination locations, generates a proposed route in response to the processing of the safety data, and provides navigation instructions corresponding to the proposed route.

### BRIEF DESCRIPTION OF THE DRAWINGS

The present invention will hereinafter be described in conjunction with the following drawing figures, wherein like numerals denote like elements, and

FIG. 1 is a schematic representation of an example environment in which a vehicle navigation system may be deployed;

FIG. 2 is a schematic representation of a vehicle navigation system configured in accordance with an example embodiment of the invention;

FIG. 3 is a schematic representation of a navigation system processor suitable for use with an example embodiment of the invention;

FIG. 4 is a flow diagram of a safety optimized navigation process suitable for use with an example embodiment of the invention; and

FIG. 5 is a flow diagram of a safety data processing method suitable for use with an example embodiment of the invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of practical vehicle navigation system platforms, architectures, and deployments, and that the particular system described herein is merely one exemplary application for the invention.

For the sake of brevity, conventional techniques related to signal processing, data transmission, general vehicle navigation system operation, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description may refer to components or features being “connected” or “coupled” together. As used herein, unless expressly stated otherwise, “connected” means that one component/feature is directly or indirectly connected to another component/feature, and not necessarily mechanically. Likewise, unless expressly stated otherwise, “coupled” means that one component/feature is directly or indirectly coupled to another component/feature, and not necessarily mechanically. Thus, although the schematic block diagrams depict example arrangements of elements, additional intervening elements, devices, features, or components may be present in an actual embodiment (assuming that the functionality of the systems or subsystems are not adversely affected).

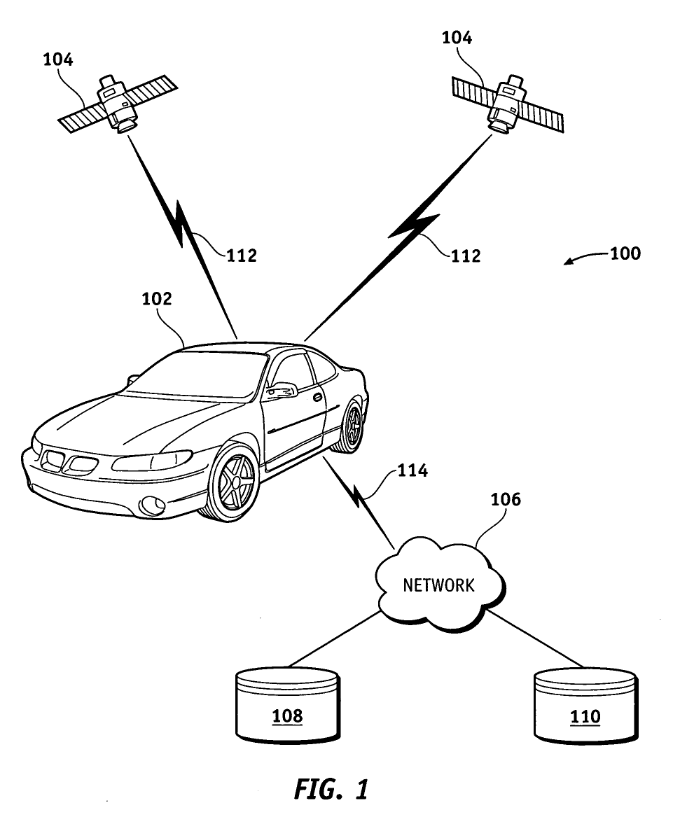

FIG. 1 is a schematic representation of an example environment 100 in which a vehicle navigation system may be deployed. A vehicle navigation system according to a practical embodiment of the invention may be deployed in environment 100. Environment 100 generally includes a vehicle 102, global positioning system (“GPS”) satellites 104, a data communication network 106, and one or more safety data sources 108/110. Although vehicle 102 is depicted as an automobile, the invention is not limited to automobile applications (the navigation system described herein may be utilized for boats, bicycles, and the like). Vehicle 102 preferably includes an onboard vehicle navigation system (not shown) that is suitably configured to provide navigation instructions to the operator of vehicle 102, where such navigation instructions direct the operator to drive along a proposed route from a desired starting location to a desired destination location. In practice, the vehicle navigation system may be incorporated into an otherwise conventional onboard vehicle computer system.

In a practical embodiment, the vehicle navigation system deployed in vehicle 102 may include logical or functional elements realized by hardware, software, firmware, or any combination thereof, such as one or more processors, controllers, memory elements, or the like. In accordance with the practices of persons skilled in the art, embodiments of the invention may be described herein with reference to symbolic representations of operations that may be performed by various logical, functional, or processor-based components. Such operations are sometimes referred to as being computer-executed, computerized, software-implemented, or computer-implemented. It will be appreciated that operations that are symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (“EROM”), a floppy diskette, a CD-ROM or any optical disk, a hard disk, a fiber optic medium, a radio frequency (“RF”) link, or the like. Data signals referred to herein may include any signal that can propagate over a transmission medium such as electronic network channels, optical fibers, air, electromagnetic paths, or RF links.

Environment 100 supports one practical vehicle navigation system that leverages a GPS system to obtain accurate position data for vehicle 102. In this regard, GPS satellites 104 may communicate, via links 112, with a conventional GPS receiver located at vehicle 102. The operation of GPS systems is known to those skilled in the art, and such known features will not be described herein. Alternatively (or additionally), the vehicle navigation system may utilize positioning data provided by a cellular telecommunication network or any appropriate locating system. Alternatively (or additionally), the vehicle navigation system may rely on the operator to enter the current location or desired starting location (e.g., an address), and the vehicle navigation system need not determine the real-time position of vehicle 102.

Safety data sources 108/110 generally contain statistical and/or real-time data indicative of the relative safety of route sections that may be traveled by vehicle 102. Specific examples of such safety data are presented below. In environment 100, the navigation system in vehicle 102 accesses safety data sources 108/110 via data communication network 106 and one or more wireless links 114. Wireless link 114 may, for example, represent a data communication link carried by a cellular service provider, and data communication network 106 may, for example, represent a cellular telecommunication network, the Internet, a LAN, any known network topology or configuration, portions thereof, or any combination thereof. Such a wireless deployment enables the vehicle navigation system to access server based safety data sources 108/110, which may be updated periodically or in real-time. Alternatively (or additionally), the navigation system for vehicle 102 may access one or more onboard safety data sources, which may be stored in a suitable memory location or provided on portable media such as a CD-ROM or a DVD-ROM. Indeed, in one alternate embodiment, vehicle 102 employs a fully onboard navigation system that need not communicate with GPS satellites 104 or any remote safety data sources 108/110.

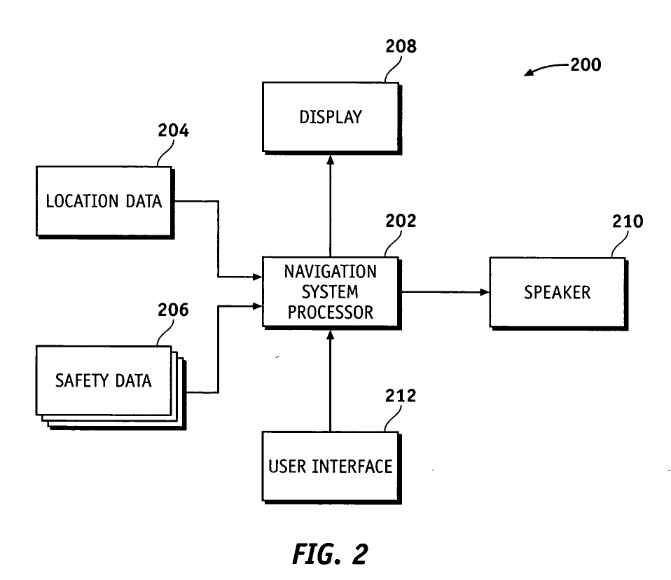

FIG. 2 is a schematic representation of a vehicle navigation system 200 configured in accordance with an example embodiment of the invention. Vehicle navigation system 200 generally includes a navigation system processor 202, a location data source 204 coupled to navigation system processor 202, safety data source(s) 206 coupled to navigation system processor 202, a display element 208 coupled to navigation system processor 202, a speaker element 210 coupled to navigation system processor 202, and a user interface 212 coupled to navigation system processor 202. In practice, the components are coupled to navigation system processor 202 in a manner that facilitates the communication of data, instructions, control signals, and possibly other signals to and from navigation system processor 202. Of course, a practical vehicle navigation system 200 may include additional components configured to perform conventional functions that are unrelated to the invention.

Generally, navigation system processor 202 is configured to perform or otherwise support the various operations and functions described herein. Location data source 204 preferably provides the current vehicle location or position to navigation system processor 202. In one practical embodiment, location data source 204 is realized as an onboard GPS receiver/processor that derives the current position of the vehicle from GPS data received by the vehicle in real-time. It should be appreciated that location data source 204 and any corresponding logical elements, individually or in combination, are example means for obtaining a starting location utilized by vehicle navigation system 200.

Safety data source(s) 206 represent locally stored, cached, downloaded, or accessible safety data, which can be processed by navigation system processor 202. For example, in a fully onboard implementation, safety data source(s) 206 may be realized as one or more hard disks, semiconductor memory devices, portable storage media, or the like. In an alternate embodiment, safety data source(s) 206 may be realized as an onboard memory cache that temporarily stores safety data downloaded from remote databases (such as safety data sources 108/110 shown in FIG. 1).

Display element 208, speaker element 210, and user interface 212 may be configured in accordance with conventional vehicle navigation systems to enable onboard interaction with the vehicle operator. Display element 208 may be a suitably configured LCD, plasma, CRT, or head-up display, which may or may not be utilized for other vehicle functions. In accordance with known techniques, navigation system processor 202 can provide rendering control signals to display element 208 to cause display element 208 to render maps, proposed routes, roads, navigation direction arrows, and other graphical elements as necessary to support the function of vehicle navigation system 200. It should be appreciated that display element 208 and any corresponding logical elements, individually or in combination, are example means for providing navigation instructions for a proposed route.

Speaker element 210 may be devoted to vehicle navigation system 200, it may be realized as part of the audio system of the vehicle, or it may be realized as part of another system or subsystem of the vehicle. Briefly, speaker element 210 may receive audio signals from navigation system processor 202, where such audio signals convey navigation instructions, user prompts, warning signals, and other audible signals as necessary to support the function of vehicle navigation system 200. It should be appreciated that speaker element 210 and any corresponding logical elements, individually or in combination, are example means for providing navigation instructions for a proposed route.

Although not shown in FIG. 2, vehicle navigation system 200 may also include a printer that generates navigation instructions in a suitable hard copy format. For example, the printer may produce a printed map that indicates the proposed route, or a printed step-by-step route plan.

User interface 212 is configured to allow the vehicle operator to enter data and/or control the functions and features of vehicle navigation system 200. For example, the operator can manipulate user interface 212 to enter a starting location and a destination location for the vehicle, where the starting and destination locations are utilized by vehicle navigation system 200 for purposes of route planning. If the desired starting location corresponds to the current vehicle location, then the operator need not enter the starting location if vehicle navigation system 200 includes a source of current vehicle position information. User interface 212 may be realized using any conventional device or structure, including, without limitation: a keyboard or keypad; a touch screen (which may be incorporated into display element 208); a voice recognition system; a cursor control device; a joystick or knob; or the like. It should be appreciated that user interface 212 and any corresponding logical elements, individually or in combination, are example means for obtaining a starting location utilized by vehicle navigation system 200, and example means for obtaining a destination location utilized by vehicle navigation system 200.

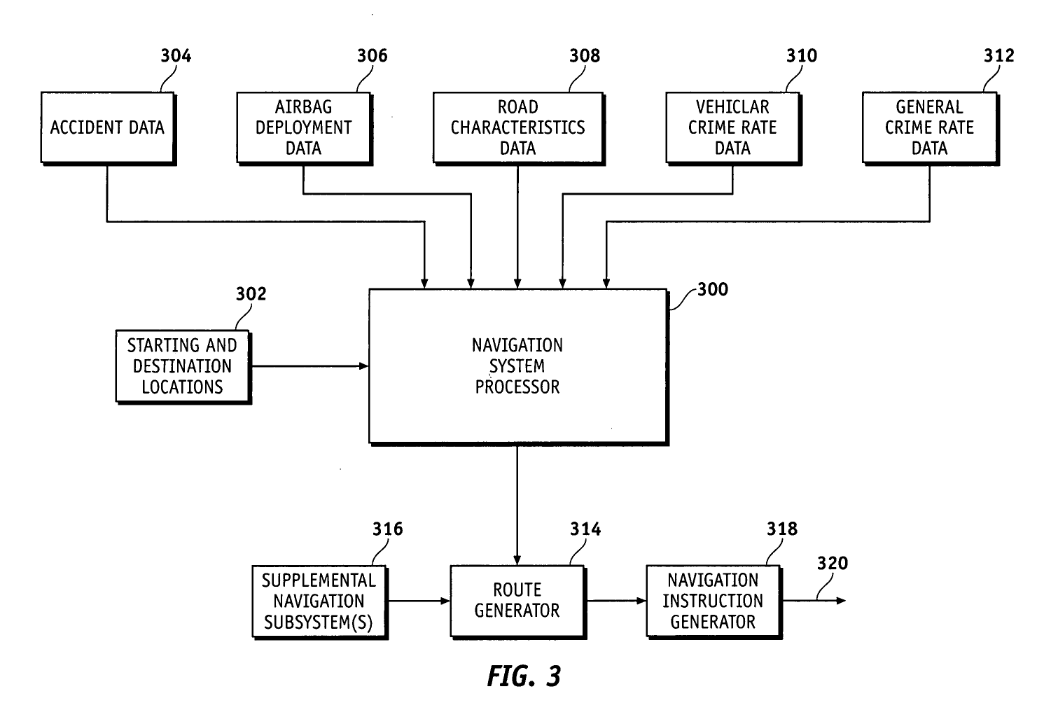

FIG. 3 is a schematic representation of a navigation system processor 300 suitable for use with an example embodiment of the invention. Navigation system processor 300 is suitable for use as navigation system processor 202 (see FIG. 2). As mentioned briefly above, navigation system processor 300 obtains, receives, or accesses starting and destination locations 302, and generates one or more proposed routes between the starting location and the destination location, where the proposed routes are generated to favor relatively safe routes over relatively unsafe routes. In this regard, navigation system processor 300 and any corresponding logical elements, individually or in combination, are example means for obtaining a starting location, and example means for obtaining a destination location.

Navigation system processor 300 also obtains, receives, or accesses safety data from one or more safety data sources. FIG. 3 depicts different safety data types that may be considered in a practical deployment of the invention. As used herein, a “safety data type” refers to a class, category, group, or set of data that share at least one common trait, feature, or characteristic. An example navigation system processor 300 may handle one or more of the following safety data types: accident data 304; airbag deployment data 306; road characteristics data 308; vehicular crime rate data 310; and general crime rate data 312. It should be appreciated that any number and combination of safety data types, including more or less than those shown in FIG. 3, may be processed by navigation system processor 300. Furthermore, in practice, any number of different safety data types may be obtained, received, or accessed from a single source or database. In the preferred practical embodiment of the invention, the safety data is suitably formatted for compatibility with navigation system processor 300 or converted into an appropriate format by navigation system processor 300 prior to handling.

Generally, the safety data corresponds to specific route sections (e.g., road or highway segments, intersections, on/off ramps, city blocks, geographic regions, etc.) under consideration by navigation system processor 300. In practice, the route sections are considered for purposes of generating a proposed route between the starting and destination locations, and a proposed route will typically include a plurality of route sections.

Accident data 304 may include statistical accident rate data, real-time accident event data, accident severity data, and other accident related data corresponding to the particular route sections under consideration. In a practical embodiment, accident data 304 may be obtained, accessed, or derived from various public or private sources, including, without limitation: law enforcement bodies; public transportation agencies, such as state departments of transportation; National Highway Traffic Safety Administration (“NHTSA”); Insurance Institute for Highway Safety (“IIHS”); or American Automobile Association (“AAA”). In a practical embodiment, route sections having relatively high accident rates will be less favored than route sections having relatively low accident rates.

Airbag deployment data 306 may include statistical data related to actual airbag deployments corresponding to the particular route sections under consideration. Navigation system processor 300 may assume that a high frequency of airbag deployment indicates a relatively unsafe route section, compared to a route section having little or no history of airbag deployments. In this regard, the vehicle navigation system can leverage the airbag deployment notification feature found in known vehicle monitoring systems, such as the system provided by ONSTAR®. The ONSTAR® airbag notification feature communicates with a central service center to log each airbag deployment along with the geographic location of the vehicle involved. Consequently, airbag deployment data 306 may represent a suitably formatted and compiled collection of such log data.

Road characteristics data 308 may include statistical and/or real-time data indicative of safety-related characteristics of the particular route sections under consideration. For example, road characteristics data 308 may include road geometry data, including, without limitation: the total number of lanes; the number of carpool lanes; the width of individual lanes; the number of roads at an intersection; the number or severity of curves in a road segment; the number of bridges, tunnels, or elevated sections in a road segment; or the number of on/off ramps in a road segment. Some road geometry data, which may be based on cartographic sources, is readily available and currently used with existing vehicle navigation systems, while some vendors offer software applications that analyze road topologies for purposes of accident prediction. It should be appreciated that navigation system processor 300 can be suitably configured to leverage these and other existing road geometry data sources. Road characteristics data 308 may also include traffic management data, including, without limitation: the number of traffic lights in a road segment; the number of stop signs in a road segment; whether an intersection includes a left turn lane or a left turn signal; or the speed limits in road segments. Road characteristics data 308 may also include road composition data, including, without limitation: the age of the road segments; the composition of the road surface, e.g., asphalt, concrete, rubberized, gravel, dirt, or the like; whether a given road segment includes texturing for the prevention of hydroplaning; whether a given road segment is susceptible to rain, snow, or ice; or the number of potholes, cracks, or other surface defects in a road segment. In a practical embodiment, route sections having certain road characteristics (e.g., winding roads, narrow roads, roads with high speed limits, or older roads) will be less favored, while route sections having other road characteristics (e.g., straight roads, newer paved roads, or roads with few on/off ramps) will be more favored.

Vehicular crime rate data 310 may include statistical and/or real-time data related to the rate or severity of vehicular crime associated with the particular route sections under consideration (and the geographical areas surrounding the route sections under consideration). In this regard, vehicular crimes include carjacking, hit-and-run incidents, vandalism or theft, “reckless driving” incidents, “driving under the influence” incidents, or the like. In a practical embodiment, vehicular crime rate data 310 may be obtained, accessed, or derived from various public or private sources, including, without limitation: law enforcement bodies; insurance companies; and vehicle security companies. In a practical embodiment, route sections having relatively high vehicular crime rates will be less favored than route sections having relatively low vehicular crime rates.

General crime rate data 312 may include statistical and/or real-time data related to the rate or severity of non-vehicular crime associated with the particular route sections under consideration (and the geographical areas surrounding the route sections under consideration). Such general crime rate data may be obtained, accessed, or derived from various public or private sources, including, without limitation: law enforcement bodies; home or business security companies; news agencies; or government surveys. In a practical embodiment, route sections having relatively high non-vehicular crime rates will be less favored than route sections having relatively low non-vehicular crime rates.

Navigation system processor 300 is configured to process safety data corresponding to a number of route sections between the starting location and the destination location. The processed safety data may include any amount of data corresponding to any number of safety data types as described above. Briefly, the safety data is suitably processed to favor relatively safe routes over relatively unsafe or statistically dangerous routes. An example processing algorithm is described in more detail below. In practice, navigation system processor 300 strives to avoid unsafe road segments, geographical regions, and route sections (within practical limitations) to provide a safe traveling route to the destination location. Navigation system processor 300 may include or communicate with a suitably configured route generator 314 that generates a proposed route between the starting location and the destination location. In practice, route generator 314 calculates the proposed route in response to the processing of the safety data, such that the proposed route is at least partially influenced by safety concerns. It should be appreciated that navigation system processor 300, route generator 314, and any corresponding logical elements, individually or in combination, are example means for generating a proposed route to the destination location.

Navigation system processor 300 and/or route generator 314 may also cooperate with one or more supplemental navigation subsystems 316 to further enhance the generation of the proposed route. Although FIG. 3 depicts supplemental navigation subsystems 316 as a distinct processing block, a practical implementation might combine the processing of all selected optimizations when generating proposed routes. In other words, the functionality of supplemental navigation subsystems 316 as described herein may be incorporated into navigation system processor 300. Supplemental navigation subsystem 316 may leverage existing route optimization technologies, such as navigation algorithms that select routes to minimize the distance traveled, to minimize the drive time, or to avoid traffic congestion. In this regard, the vehicle navigation system may allow the vehicle operator to enter weighting factors for the different optimization schemes, disable one or more optimization schemes, or otherwise customize the manner in which navigation system processor 300, supplemental navigation subsystems 316, and route generator 314 arrive at the proposed route. For example, the vehicle operator may desire a route that is optimized for safety at the expense of overall drive time, or vice versa. As another example, one useful implementation may combine safety optimization with a traditional optimization such as “fastest,” to yield routes that are reasonably “fast” but not too “unsafe.”

Navigation system processor 300 may include or otherwise communicate with a navigation instruction generator 318, which is suitably configured to provide navigation instructions 320 corresponding to the proposed route generated by route generator 314. Referring to FIG. 2, the navigation instructions 320 may be formatted for rendering at display element 208 or for audible broadcast by speaker element 210. It should be appreciated that navigation system processor 300, navigation instruction generator 318, and any corresponding logical elements, individually or in combination, are example means for providing navigation instructions for a proposed route.

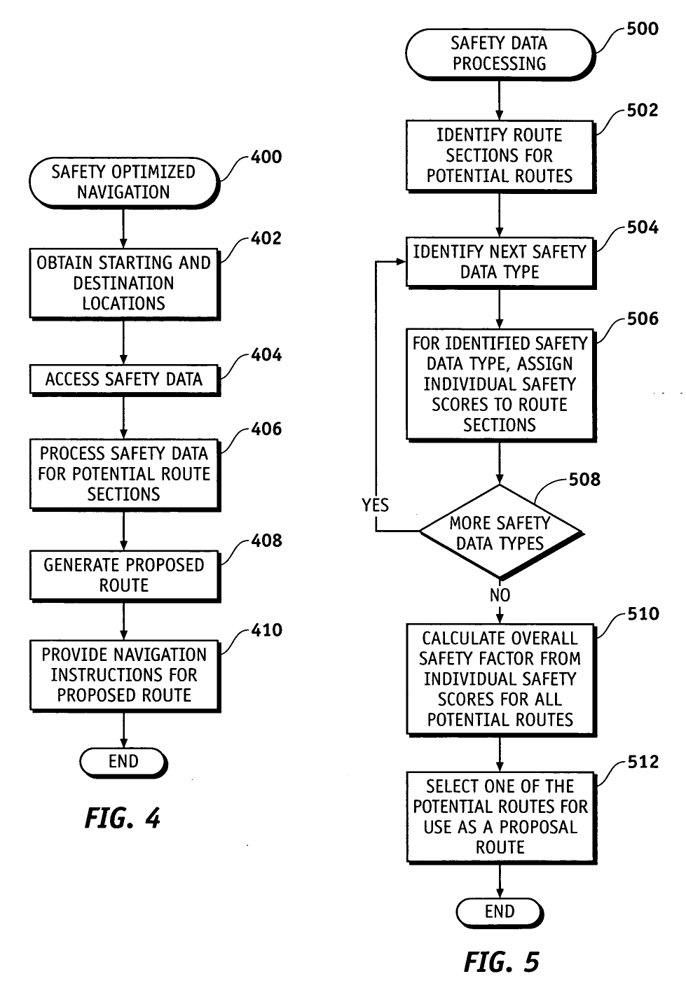

In practical embodiments of the invention, navigation system processor 300, route generator 314, and/or navigation instruction generator 318 are configured to perform a number of methods, processes, techniques, and tasks associated with the generation of a safety-optimized vehicle navigation route. For example, FIG. 4 is a flow diagram of a safety optimized navigation process 400 suitable for use with an example embodiment of the invention. The various tasks performed in connection with process 400 may be performed by software, hardware, firmware, or any combination thereof. For illustrative purposes, the following description of process 400 may refer to elements mentioned above in connection with FIGS. 1-3. In practical embodiments, portions of process 400 may be performed by different elements of the described system, e.g., navigation system processor 300, route generator 314, navigation instruction generator 318, display element 208, or the like. It should be appreciated that process 400 may include any number of additional or alternative tasks, the tasks shown in FIG. 4 need not be performed in the illustrated order, and process 400 may be incorporated into a more comprehensive procedure or process having additional functionality not described in detail herein. In this regard, process 400 may include additional tasks (not shown) that enable the combination of safety-driven route planning with traditional route planning techniques as described above in connection with supplemental navigation subsystems 316.

Safety optimized navigation process 400 may begin with a task 402, which obtains a starting location and a destination location for the vehicle. The starting and destination locations may be utilized to determine one or more potential routes or potential route sections. Thereafter, process 400 accesses safety data (task 404), which may be stored locally at the vehicle or remote from the vehicle. As mentioned previously, the safety data may be associated with any number of different types, and any amount of safety data may be accessed during task 404. Process 400 may be designed to only access a limited amount of safety data, e.g., data corresponding to the potential routes or potential route sections. The safety data for those potential route sections can then be processed in a suitable manner (task 406). As described in more detail below, the safety data is processed by an appropriate algorithm that strives to generate a relatively safe navigation plan.

In response to the processing of the safety data, process 400 generates a proposed route to the destination location (task 408). In the practical embodiment of the invention, the proposed route is generated in a manner that favors relatively safe routes over relatively unsafe routes. Depending upon the practical implementation, process 400 may generate more than one proposed route for selection by the vehicle operator. Eventually, process 400 provides navigation instructions corresponding to the proposed route to the vehicle operator (task 410). The navigation instructions may be realized as graphical reminders, audible warnings or instructions, a printed map indicating the proposed route, or the like.

FIG. 5 is a flow diagram of a safety data processing method 500 suitable for use with an example embodiment of the invention. It should be appreciated that a practical vehicle navigation system may utilize a different processing algorithm (or algorithms) and that method 500 is merely one example algorithm. The various tasks performed in connection with method 500 may be performed by software, hardware, firmware, or any combination thereof. For illustrative purposes, the following description of process 500 may refer to elements mentioned above in connection with FIGS. 1-3. In practical embodiments, portions of method 500 may be performed by different elements of the described system, e.g., navigation system processor 300 or route generator 314. It should be appreciated that method 500 may include any number of additional or alternative tasks, the tasks shown in FIG. 5 need not be performed in the illustrated order, and method 500 may be incorporated into a more comprehensive procedure or process having additional functionality not described in detail herein.

Safety data processing method 500 begins by identifying route sections for potential routes (task 502) to the desired destination location. Assuming that a plurality of safety data types are contemplated by the vehicle navigation system, method 500 also identifies the next safety data type for consideration (task 504). For the current safety data type, method 500 assigns individual safety scores to a number of the route sections identified during task 502. A safety score may be any quantity, such as a numerical score, that is indicative of the relative safety level for a particular route section. For example, a statistically safe route section having an extremely low accident rate and an extremely low crime rate may be assigned a relatively low safety score (such as zero), while a statistically unsafe route section having a high accident rate, a high crime rate, or uncharacteristically poor surface conditions may be assigned a relatively high safety score (such as nine). The safety scores may fall within any suitable range, and different safety data types may have higher or lower ranges depending upon their relative weightings.

If safety data processing method 500 has processed all of the safety data types (query task 508), then a task 510 can be performed. Otherwise, if more safety data types remain for processing, then task 504 can be re-entered to gather more individual safety scores for the potential routes. After all of the individual safety scores have been assigned, method 500 calculates an overall safety factor for each potential route (task 510). Each overall safety factor is based on the individual safety scores for the respective potential route. An overall safety factor can be calculated using any number of techniques, depending upon the implementation of the vehicle navigation system. For example, the overall safety factor for a potential route may be a simple sum or a weighted sum of the individual safety scores for that route. Alternatively, the overall safety factor for a potential route may be calculated using a more complex formula or mathematical expression that considers some or all of the individual safety scores for that route.

Ultimately, safety data processing method 500 selects one of the potential routes for use as a proposed route (task 512). Alternatively, method 500 may select a plurality of potential routes, which allows the vehicle operator to choose between different optional routes. In practice, task 512 may select the “best” potential route based upon the overall safety factors. For example, task 512 may select the potential route having the lowest overall safety factor sum, and designate that potential route as the proposed route for presentation to the vehicle operator.

Notably, once the safety data for road sections is identified and accessed, incorporating the safety data into a route planning strategy is conceptually straightforward. The route processing engine can be considered to be a cost minimizer, searching the space of possible routes for the least-costly candidate. The cost of a candidate route may be the sum of the costs of the constituent road sections, intersections, and geographical regions. For instance, gravel roads and left turns might be considered more costly than multi-lane paved roads and right turns. In the same vein, accident prone spots could be assigned higher costs than statistically safer spots. In this manner, the routing engine tends to avoid unsafe areas because routes that include such areas become more costly than equivalent routes that avoid unsafe areas.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A navigation method for instructing an operator of a vehicle, said method comprising:
obtaining a starting location and a destination location;
processing safety data corresponding to a number of route sections 5 between said starting location and said destination location;
generating a proposed route in response to said processing step; and
providing navigation instructions corresponding to said proposed route.

2. A navigation method according to claim 1, said generating step favoring relatively safe routes over relatively unsafe routes.

3. A navigation method according to claim 1, said processing step comprising:
assigning individual safety scores to said number of route sections; and
calculating an overall safety factor based on said individual safety scores, said overall safety factor corresponding to a potential route.

4. A navigation method according to claim 1, said processing step comprising:
assigning individual safety scores to said number of route sections; and
calculating, for each of a plurality of potential routes, an overall safety factor based on said individual safety scores.

5. A navigation method according to claim 4, said generating step comprising selecting one of said plurality of potential routes as said proposed route.

6. A navigation method according to claim 1, said safety data comprising airbag deployment data.

7. A navigation method according to claim 1, said safety data comprising crime rate data.

8. A navigation method according to claim 7, said crime rate data comprising vehicular crime rate data.

9. A navigation method according to claim 1, said safety data comprising accident rate data.

10. A navigation method according to claim 1, said safety data comprising road characteristic data.

11. A navigation method according to claim 10, said road characteristic data comprising road geometry data.

12. A navigation method according to claim 10, said road characteristic data comprising road composition data.

13. A navigation system for instructing an operator of a vehicle, said system comprising:
means for obtaining a starting location;
means for obtaining a destination location;
a processor configured to process safety data corresponding to a number of route sections between said starting location and said destination location;
means for generating a proposed route in response to processing of said safety data; and
means for providing navigation instructions corresponding to said proposed route.

14. A navigation system according to claim 13, said processor being configured to:
assign individual safety scores to said number of route sections; and
calculate an overall safety factor based on said individual safety scores, said overall safety factor corresponding to a potential route.

15. A navigation system according to claim 13, said processor being configured to:
assign individual safety scores to said number of route sections; and
calculate, for each of a plurality of potential routes, an overall safety factor based on said individual safety scores.

16. A navigation system according to claim 15, said means for generating being configured to select one of said plurality of potential routes as said proposed route.

17. A computer program architecture for providing navigation directions to an operator of a vehicle, said computer program architecture being embodied on computer-readable media, said computer program architecture having computer-executable instructions comprising:
instructions for obtaining a starting location and a destination location;
instructions for processing safety data corresponding to a number of route sections between said starting location and said destination location;
instructions for generating a proposed route in response to said 10 processing step; and
instructions for providing navigation directions corresponding to said proposed route.

18. A computer program architecture according to claim 17, further comprising:
instructions for assigning individual safety scores to said number of route sections; and
instructions for calculating an overall safety factor based on said individual safety scores, said overall safety factor corresponding to a potential route.

19. A computer program architecture according to claim 17, further comprising:
instructions for assigning individual safety scores to said number of route sections; and
instructions for calculating, for each of a plurality of potential routes, an overall safety factor based on said individual safety scores.

20. A computer program architecture according to claim 19, further comprising instructions for selecting one of said plurality of potential routes as said proposed route.
